(19) United States
(12) Patent Application Publication
(10) Pub. No.: US 2025/0350751 A1
(43) Pub. Date: Nov. 13, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yichen ZHOU, Beijing (CN); Xiaoqi MA, Beijing (CN); Yingzhan XU, Beijing (CN); Kai ZHANG, Los Angeles, CA (US); Li ZHANG, Los Angeles, CA (US); Xinfeng ZHANG, Beijing (CN)

(21) Appl. No.: 19/274,393

(22) Filed: Jul. 18, 2025

Related U.S. Application Data
(63) Continuation of application No. PCT/CN2024/072870, filed on Jan. 17, 2024.

(30) Foreign Application Priority Data
Jan. 19, 2023 (WO) PCT/CN2023/073262

(51) Int. Cl. H04N 19/33; G06T 9/00; H04N 19/172

(52) U.S. Cl. CPC H04N 19/33; G06T 9/001; H04N 19/172

(57) ABSTRACT

Embodiments of the disclosure provide a solution for video processing. A method for video processing is proposed. The method includes: applying, for a conversion between a target frame of a point cloud sequence and a bitstream of the point cloud sequence, down-sampling on points in the target frame according to importance of the points; obtaining a final sampled point could by combining a plurality of down-sampled points, wherein a first set of down-sampled points is down-sampled based on importance, and a second set of down-sampled points is down-sampled based on structure-preserving information; and performing the conversion based on the final sampled point cloud.

### CROSS REFERENCE

This application is a continuation of International Application No. PCT/CN2024/072870, filed on Jan. 17, 2024, which claims the benefits of International Application No. PCT/CN2023/073262, filed on Jan. 19, 2023. The entire contents of these applications are hereby incorporated by reference in their entireties.

### FIELDS

Embodiments of the present disclosure relates generally to point cloud coding techniques, and more particularly, to point cloud geometry compression based on visual perception.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for video processing.

In a first aspect, a method for video processing is proposed. The method comprises: applying, for a conversion between a target frame of a point cloud sequence and a bitstream of the point cloud sequence, down-sampling on points in the target frame according to importance of the points; obtaining a final sampled point could by combining a plurality of down-sampled points, wherein a first set of down-sampled points is down-sampled based on importance, and a second set of down-sampled points is down-sampled based on structure-preserving information; and performing the conversion based on the final sampled point cloud. In this way, it can improve quality of compression.

In a second aspect, another method for video processing is proposed. The method comprises: performing, for a conversion between a target frame of a point cloud sequence and a bitstream of the point cloud sequence, a reprocessing on a set of features associated with the target frame; obtaining a reconstructed point cloud by applying an up-sampling to a final sampled point cloud; updating the reconstructed point cloud by adding a residual between a true point cloud and the reconstructed point cloud; and performing the conversion based on the updated the reconstructed point cloud and the set of reprocessed features. In this way, it can improve point cloud accuracy.

In a third aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a fourth aspect, a non-transitory computer-readable storage medium is proposed. The non-transitory computer-readable storage medium stores instructions that cause a processor to perform a method in accordance with the first aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; and generating the bitstream based on the final sampled point cloud.

In a sixth aspect, a method for storing a bitstream of a video is proposed. The method comprises: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; generating the bitstream based on the final sampled point cloud; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; and generating the bitstream based on the updated the reconstructed point cloud and the set of reprocessed features.

In ab eighth aspect, a method for storing a bitstream of a video is proposed. The method comprises: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; generating the bitstream based on the updated the reconstructed point cloud and the set of reprocessed features; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 shows an original U-Net network framework;

FIG. 5 shows a flow of the geometric compression method based on visual perception;

FIG. 6 shows a flow of importance sampling method with keeping the structure;

FIG. 7 illustrates a flowchart of a method for video processing in accordance with embodiments of the present disclosure;

FIG. 8 illustrates a flowchart of a method for video processing in accordance with embodiments of the present disclosure; and

FIG. 9 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

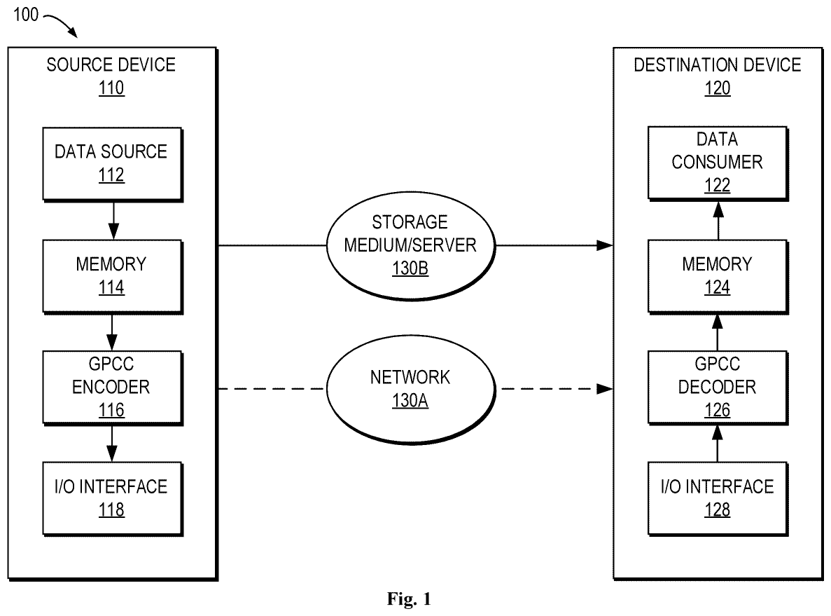

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

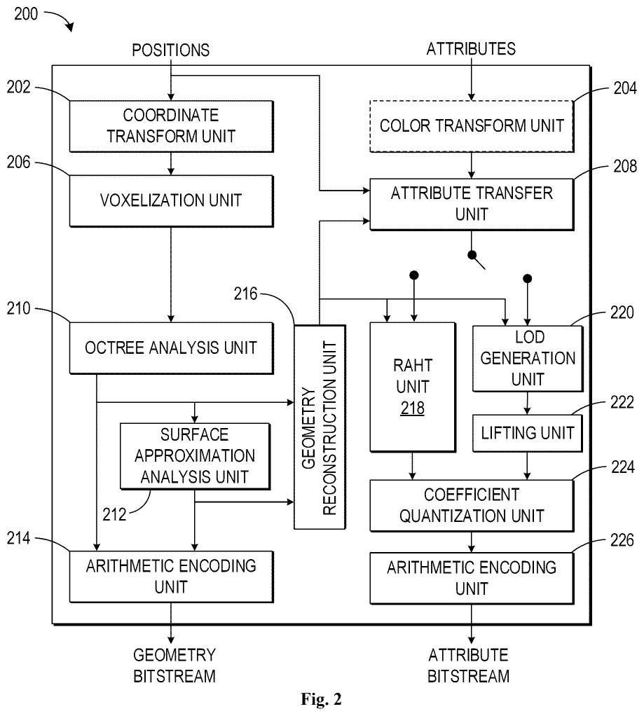

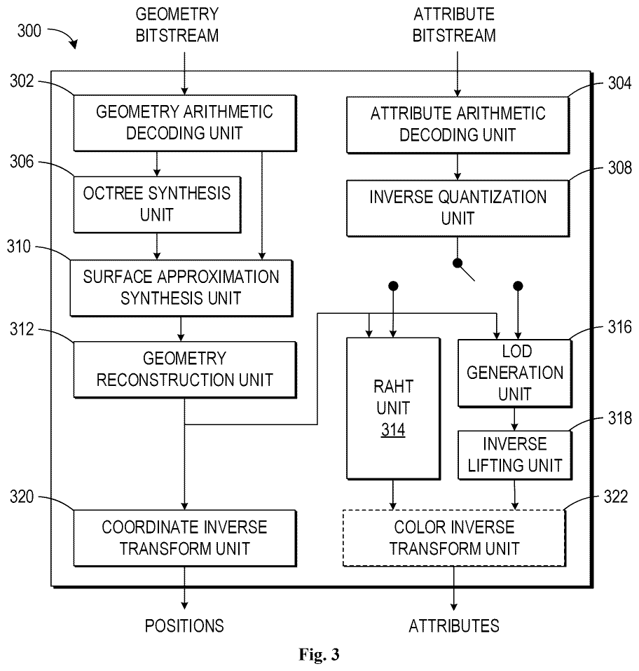

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively, or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This present disclosure is related to point cloud coding technologies. Specifically, it is related to learning-based point cloud geometry compression. The ideas may be combined with point cloud coding standard, e.g., the being-developed Geometry based Point Cloud Compression (G-PCC).

### 2. Abbreviations

G-PCC Geometry based Point Cloud Compression
MPEG Moving Picture Experts Group

### 3. Introduction

In point cloud compression, traditional octree coding, grid coding, mapping coding, and attribute coding have provided the basic ideas and framework for compression. Following their encoding principles and module structures, people use various signal processing methods to design new modules or optimize and enhance the old ones. The same is true for learning-based point cloud compression, which can replace traditional modules using neural network models and also optimize model parameters based on data-driven optimization.

In point cloud deep learning (Guo, Yulan, et al. “Deep learning for 3d point clouds: A survey.” IEEE transactions on pattern analysis and machine intelligence 43.12 (2020): 4338-4364), for CV tasks such as point cloud classification and segmentation, there are many encoder network structures that are efficient in learning compact features that contain rich details of the original point cloud. For processing tasks such as point cloud generation, complementation, enhancement, and denoising, there are many decoder network structures that are able to output high-quality point clouds from less information. There are also point cloud self-encoder networks capable of learning symmetric codec transforms. Through the transformations, the original data can be transformed into an implicit space that is more conducive to efficient compression.

Quach et al (Quach, Maurice, Giuseppe Valenzise, and Frederic Dufaux. “Learning convolutional transforms for lossy point cloud geometry compression.” 2019 IEEE international conference on image processing (ICIP). IEEE, 2019), Wang et al (Wang, Jianqiang, et al. “Lossy point cloud geometry compression via end-to-end learning.” IEEE Transactions on Circuits and Systems for Video Technology 31.12 (2021): 4909-4923), and Guarda et al (Guarda, André F R, Nuno M M Rodrigues, and Fernando Pereira. “Point cloud coding: Adopting a deep learning-based approach.” 2019 Picture Coding Symposium (PCS). IEEE, 2019) have earlier proposed a deep learning-based point cloud compression framework, proposing to transform the point cloud geometry into an occupied grid in the form of a volumetric model and designing a 3D CNN based self-encoder network to learn the codec transformation through end-to-end training. The geometric distortion is optimized using a binary loss function and the intermediate features are estimated probabilistically using an entropy model based on factorization.

### 3.1 U-Net Model

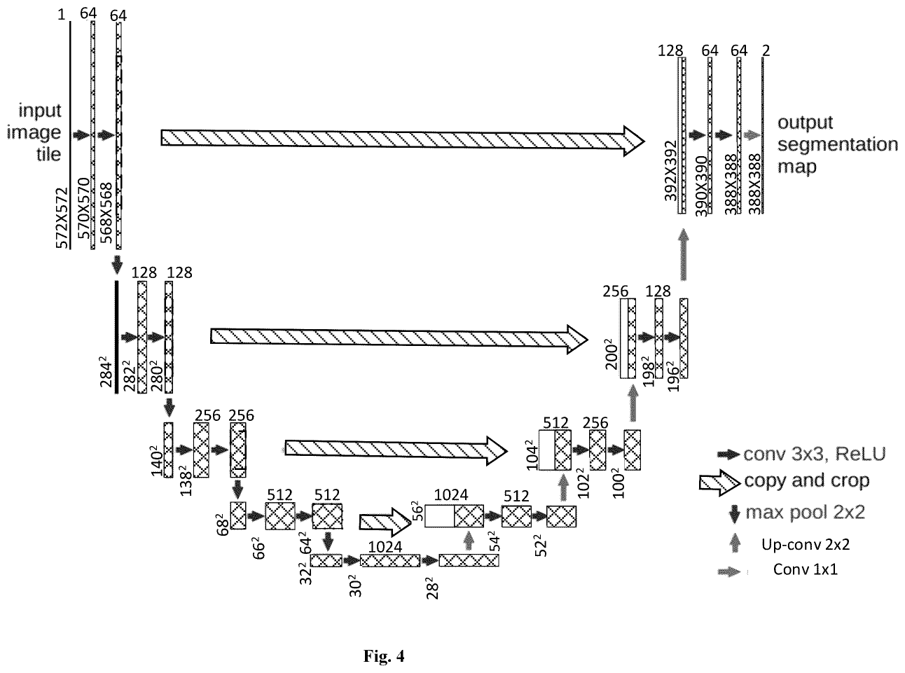

U-Net (Ronneberger, Olaf, Philipp Fischer, and Thomas Brox. “U-net: Convolutional networks for biomedical image segmentation.” International Conference on Medical image computing and computer-assisted intervention. Springer, Cham, 2015) was originally proposed to solve the problem of medical image segmentation, and its network structure is shown in the FIG. 4. Overall, this is also an Encoder-Decoder structure, where the encoder part can be seen as feature extraction and the decoder part is upsampling. Since the overall structure of the network is a larger letter U, it is called U-Net.

This structure is to first convolve and pool the images, then upsample or deconvolute the obtained feature map to get a larger feature map, which is stitched with the previous feature map of the same dimension, then convolve and upsample the stitched feature map to get the corresponding feature map, then stitch with the previous feature, convolve, and upsample again, after four times of upsampling to get A prediction result with the same size as the input image.

Since this U-shaped network structure can effectively obtain contextual and location information, this structure is widely used in various tasks.

### 3.2 Sparse Convolution

To exploit the sparsity of point clouds, scholars have conducted many explorations, such as octree-based CNNs (Peng-Shuai Wang, Yang Liu, Yu-Xiao Guo, Chun-Yu Sun, and Xin Tong, “O-cnn: Octree-based convolutional neural networks for 3d shape analysis,” ACM Transactions on Graphics (TOG), vol. 36, no. 4, pp. 1-11, 2017) and sparse CNNs (Christopher Choy, Jun Young Gwak, and Silvio Savarese, “4d spatio-temporal convnets: Minkowski convolutional neural networks,” in Proceedings of the IEEE Conference on Computer Vision and Pattern Recognition, 2019, pp. 3075-3084; Benjamin Graham, Martin Engelcke, and Laurens van der Maaten, “3d semantic segmentation with submanifold sparse convolutional networks,” in Proceedings of the IEEE conference on computer vision and pattern recognition, 2018, pp. 9224-9232; and Benjamin Graham, “Unsupervised learning with sparse space-and-time autoencoders,” ArXiv, vol. abs/1811.10355, 2018). For sparse CNNs, the data tensor is represented by a set of coordinates C and the associated features F. The convolution aggregates only the features that are positively occupying the coordinates. It is defined in Christopher Choy, JunYoung Gwak, and Silvio Savarese, “4d spatio-temporal convnets: Minkowski convolutional neural networks,” in Proceedings of the IEEE Conference on Computer Vision and Pattern Recognition, 2019, pp. 3075-3084 as:

$${f}_{t}^{out} = {\sum }_{i ∈ {N}^{3} ( t , {C}^{i n} )} {W}_{i} {f}_{t + i}^{in} for t ∈ {C}^{out}$$

where Cⁱⁿ and C^{out} are input coordinates and output coordinates.

$${f}_{t}^{in} and {f}_{t}^{out}$$

are input and output feature vectors at coordinate t. N³(t, Cⁱⁿ)={i|t+i∈Cⁱⁿ, i∈N³} defines a 3D convolutional kernel, covering a set of locations centered at t with offset i's in Cⁱⁿ. Wᵢ denotes the kernel value at offset i. This sparse convolution exploits the sparsity of the point cloud to reduce the complexity and computes only on the positively occupied voxels.

### 4. Problems

The existing learning-based point cloud geometry compression methods have the following problems:
1. Most of the current learning-based point cloud geometry compression methods achieve the compression task by transferring low-resolution point clouds and corresponding features, but these low-resolution point clouds often suffer from redundancy and structural irrationality. Theoretically, regions with simple structures require fewer points to decode, while regions with complex structures require more points to fit the structure of the region, but the point clouds obtained by the majority of methods is homogeneous.
2. Most of the learning-based point cloud compression methods do not perform additional processing on the features obtained from entropy decoding, but directly use the features for reconstruction of point cloud geometry. It will weaken the feature characterization ability of the original features.
3. Currently, progressive upsampling is a common reconstruction method, but the same importance of each point in each stage of the reconstruction constraint may lead to poor visual quality of the reconstruction.
4. Up-sampling is a dense reconstruction of point cloud coordinates, but this reconstruction capability is relatively limited. Other processing methods combined with point cloud upsampling methods may improve the final reconstruction quality of the point cloud. However, most methods nowadays do not reprocess the point clouds obtained by upsampling to further improve the point cloud accuracy.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.
1) In the following discussions, the term “encoder” refers to the model to code of the information to be signalled. The term “decoder” refers to the model to decode the compression bits to get the signalled information.
2) It is proposed to down sample the point cloud to get the significant points based on the importance of each point.
   a. In one example, the importance may be evaluated in terms of the geometric character of point cloud, such as geometric structure, local information of geometry or global information of geometry.
      i. Furthermore, the importance of each point in the point cloud may be evaluated using the geometric structure.
         1. In one example, the geometric structure may be characterized using a combination of local and global geometric information.
         a. In one example, the local geometric information may be represented by the fast point feature histograms of point cloud.
         b. In one example, the global geometric information may be obtained by evaluating the clusters among all the clusters obtained from the point cloud clustering process.
   b. In one example, the importance may be evaluated in terms of the attribute character of point cloud, such as color information.
   c. In one example, the importance may be evaluated in terms of both the geometric character and the attribute character of point cloud.
   d. In one example, the importance of each point, such as the importance based on the local and global geometric information, may be obtained using a learning-based approach.
      i. In one example, a neural network-based learning approach may be used to obtain the importance of each point.
         1. In one example, the neural network similar to the U-Net structural network may be used.
         a. In one example, the sparse convolution may be used as the basic operation in the convolutional network.
   e. In one example, the importance of each point in the point cloud which are learned by the network may be ranked.
   f. In one example, the points with higher importance may be sampled by sorting the importance in descending order.
3) It is proposed to use the structure-preserving information to obtain the skeleton structure of the point cloud.
   a. In one example, the structure-preserving information may be represented by density representation, point set representation, etc.
   b. In one example, the point set representation (such as uniform point set, farthest sampled point set, etc.) may be used to obtain the backbone structure of the point cloud.
      i. In one example, the farthest sampling method may be used to obtain the farthest sampled point set.
4) It is proposed to combine different down sampling method to obtain the final sampled point cloud.
   a. In one example, the final sampling point cloud may be obtained by combining local and global structure importance and structure preservation information.
      i. In one example, 10% of points may be sampled using local and global importance sampling.
      ii. In one example, 10% of points may be sampled using structure retention sampling.
      iii. In one example, the points sampled by local global importance sampling and the points sampled by structure retention sampling may be merged to obtain the final sampled point cloud.
5) It is proposed to code and signal the final sampled point cloud to the decoder.
   a. In one example, the final sampled point cloud may be coded by point cloud codec.
      i. In one example, the point cloud codec may be G-PCC, V-PCC, Draco etc.
6) It is proposed to code and signal the features to the decoder.
   a. In one example, the features may be coded with fixed-length coding, unary coding, truncated unary coding, etc. al.
   b. In one example, the features may be coding in a predictive way.
7) It is proposed to reprocess the initial features obtained by the decoder.
   a. In one example, the features reprocessing may be using convolution to expand the feature dimension only.
   b. In one example, the features reprocessing may be complex variable-point expansion operations.
   c. In on example, the features reprocessing may be performed using down-sampling, up-sampling symmetric structure of variable-point feature expansion operations.
      i. In one example, the down-sampling operation of feature reprocessing may be implemented using sparse convolution.
         1. In one example, multiple consecutive down-sampling operations may be used. For example, three consecutive down-sampling operations may be used.
      ii. In one example, the up-sampling operation may be implemented using lossless sparse deconvolution.
         1. In one example, multiple consecutive up-sampling operations may be used. For example, three consecutive up-sampling operations may be used.
8) It is proposed to get the reconstructed point cloud based on the up-sample result of the decoded point cloud.
   a. In one example, the reconstructed point cloud may be obtained directly by up-sampling in one time.
   b. In one example, the reconstructed point cloud may be obtained directly by multiple progressive up-sampling.
      i. In one example, the point cloud may be reconstructed using N up-sampling operations, such as N=3.
         1. In one example, N may be pre-defined.
         2. In one example, N may be signalled to the decoder.
         a. In one example, N may be coded with fixed-length coding, unary coding, truncated unary coding, etc. al.
      b. In one example, N may be coding in a predictive way.
   c. In one example, the sparse convolution-based generative convolution may be used to achieve point cloud up-sampling.
   d. In one example, a multi-stage unbalanced loss function may be used to constrain neural network during the training process of the up-sampling.
      i. In one example, the binary cross-entropy value may be used as the loss function in the first stage.
      ii. In one example, the numbers of points used in the loss function may be different in different stages.
         1. In one example, the top M % points of importance of the real point cloud may be used to constrain the reconstructed point cloud in the first stage.
         2. In one example, the top N % points of importance of the real point cloud may be used to constrain the reconstructed point cloud in the first stage.
         3. In one example, the top K % points of importance of the real point cloud may be used to constrain the reconstructed point cloud in the last stage.
         4. In one example, M<N<K, such as M=40, N=70, K=100.
9) It is proposed to learn the residuals between the points obtained by up-sampling and the true point cloud by a learning-based approach.
   a. In one example, a neural network approach may be used to learn the residuals between the up-sampled and real points.
      i. In one example, the neural network similar to the U-Net structural network may be used to learn the residuals between the reconstructed points and the real point cloud.
         1. In one example, the residuals may be learned using a U-Net network based on sparse convolution operations.
   b. In one example, the residuals between the reconstructed and true point clouds may be learned using supervised learning.
      i. In one example, the error between the learned residuals with reconstructed points and the true points may use to update the neural network.
      ii. In one example, the chamfer distance may be used as the loss function for residual learning.
         1. In one example, the chamfer distance may be computed as the following formula:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2}$$

where S₁ and S₂ are the sets of two point clouds. x and y are the coordinates of the points in S₁ and S₂, respectively.
10) Whether to and/or how to apply a method disclosed above may be signaled from encoder to decoder in a bitstream/frame/tile/slice/octree/etc.
11) Whether to and/or how to apply the disclosed methods above may be dependent on coded information, such as dimensions, colour format, colour component, slice/picture type.

### 6. EMBODIMENTS

An example of the flow for the geometric compression method based on visual perception is as follows. Firstly, the point clouds are downsampled according to the importance of points, so that points with high importance are sampled more and points with low importance are sampled less, thus achieving adaptive downsampling. Secondly, the initial features of the decoder are reprocessed to improve the characterization ability of the features and construct the feature context for the point cloud reconstruction. Thirdly, the point clouds are reconstructed using progressive upsampling to reduce the reconstruction difficulty, and the reconstruction results are constrained using unbalanced losses at each stage, where the losses are more biased towards regions with more complex structures. Thus, the unbalanced loss constraint could make the reconstruction better for the more complex regions. Last, the geometric coordinate residuals between the point cloud obtained by progressive upsampling and the real point cloud are learnt, so that the point cloud coordinates obtained by upsampling plus the geometric coordinate residuals are more similar to the real point cloud coordinates.

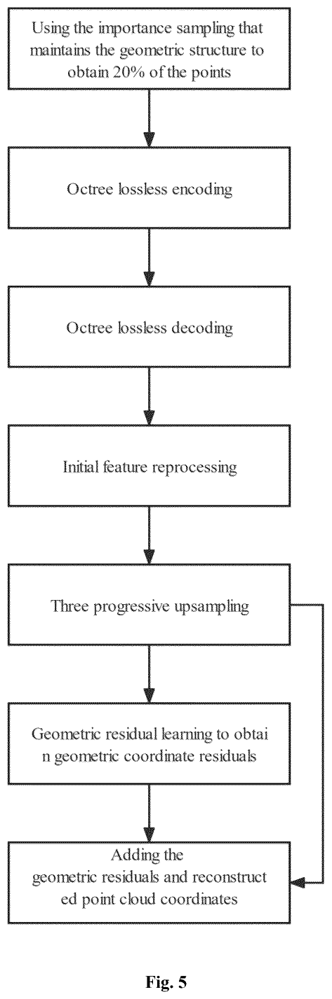

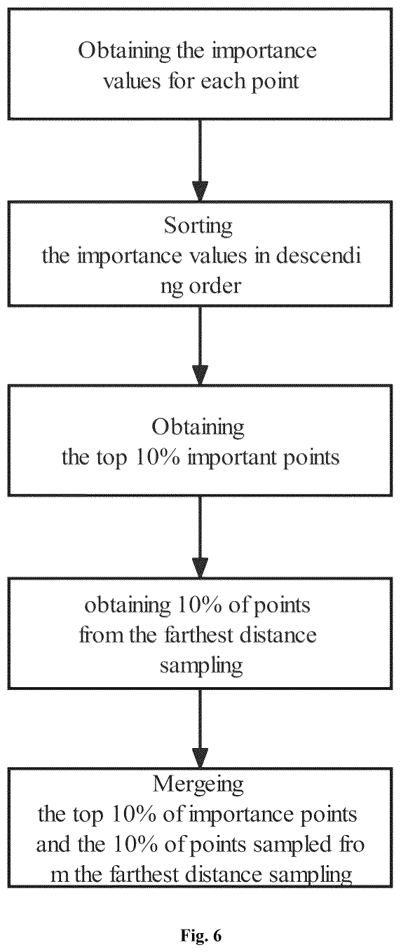

An example of the coding flow for the geometric compression method based on visual perception is depicted in FIG. 5. FIG. 6 depicts an example of the flow of the importance sampling method that maintains the geometric structure.

More details of the embodiments of the present disclosure will be described below which are related to point cloud geometry compression based on visual perception. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence.

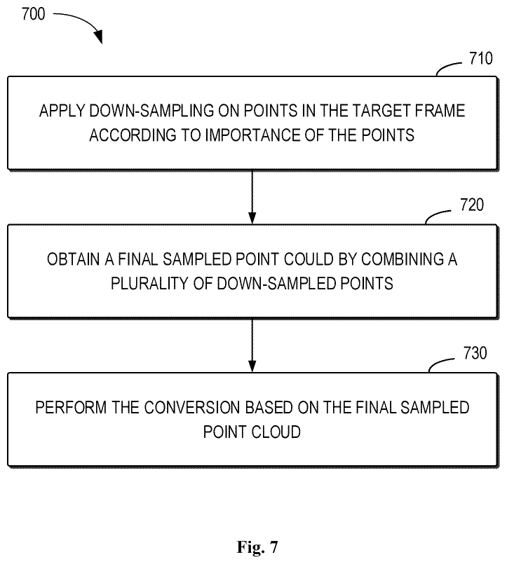

FIG. 7 illustrates a flowchart of a method 700 for video processing in accordance with embodiments of the present disclosure. The method 700 may be implemented during a conversion between a current frame of a point cloud sequence and a bitstream of the point cloud sequence.

At block 710, for a conversion between a target frame of a point cloud sequence and a bitstream of the point cloud sequence, down-sampling is applied on points in the target frame according to importance of the points.

At block 720, a final sampled point could is obtained by combining a plurality of down-sampled points, wherein a first set of down-sampled points is down-sampled based on importance, and a second set of down-sampled points is down-sampled based on structure-preserving information.

At block 730, the conversion is performed based on the final sampled point cloud. In some embodiments the conversion may include encoding the target frame into the bitstream. Alternatively, the conversion may include decoding the target frame from the bitstream. Compared with the conversion solution, it can improve quality of compression, and thus improve the efficiency of point cloud coding.

In some embodiments, the first set of down-sampled points is obtained based on importance of each point. In some embodiments, the importance is evaluated based on a geometric character of point cloud. For example, the geometric character comprises at least one of: a geometric structure, local information of geometry, or global information of geometry. In some embodiments, the importance of each point in the point is evaluated using the geometric structure. In some embodiments, the geometric structure is characterized using a combination of the local and global geometric information. In an example, the local geometric information is represented by a fast point feature histograms of point cloud. In another example, the global geometric information is obtained by evaluating clusters among all clusters obtained from a point cloud clustering process.

In some embodiments, the importance is evaluated based on an attribute character of point cloud. For example, the attribute character comprises color information. In some other embodiments, the importance is evaluated based on both geometric character and attribute character of point cloud.

In some embodiments, the importance of each point is obtained using a learning-based approach. For example, the importance may be based on the local and global geometric information.

In some embodiments, a neural network-based learning approach is used to obtain the importance of each point. In some other embodiments, the neural network which is similar to a U-Net structural network is used. In some embodiments, a sparse convolution is used as a basic operation in a convolutional network.

In some embodiments, the importance of each point in a point cloud associated with the target frame learned by the network is ranked. In some other embodiments, points with higher importance are sampled by sorting importance in descending order.

In some embodiments, the structure-preserving information is used to obtain a structure of a point could associated with the target frame. The structure may be a main structure or a basic structure of the point cloud.

In some embodiments, the structure-preserving information is represented by at least one of: a density representation, or a point set representation. In some other embodiments, the point set representation is used to obtain a backbone structure of the point cloud. The point set representation may include one or more of: uniform point set, or farthest sampled point set. In some embodiments, a farthest sampling approach is used to obtain a farthest sampled point set.

In some embodiments, the final sampled point cloud is obtained by combining local and global structure importance and structure preservation information. In some embodiments, the first set of down-sampled points is sampled using local and global importance sampling. For example, 10% of points are sampled using the local and global importance sampling. In some embodiments, the second set of down-sampled points is sampled using structure retention sampling. As another example, 10% of points are sampled using the structure retention sampling.

In some embodiments, the final sampled point cloud is coded and indicated to a decoder by an encoder. For example, the final sampled point cloud is coded by a point cloud codec. In some embodiments, the point cloud codec is one of: a geometry based point cloud compression (G-PCC), a video based point cloud compression (V-PCC), or Draco.

In some embodiments, a set of features is coded and indicated to a decoder by an encoder. For example, the set of features is coded with one of: fixed-length coding, unary coding, or truncated unary coding. As another example, the set of features is coding in a predictive way.

In some embodiments, whether to and/or how to obtain the final sampled point could by combining the plurality of down-sampled points is indicated from an encoder to a decoder in one of: a bitstream, a frame, a tile, a slice, or an octree. In some embodiments, whether to and/or how to obtain the final sampled point could by combining the plurality of down-sampled points is dependent on coding information. The coding information may include at least one of: dimensions, colour format, colour component, slice type, or picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; and generating the bitstream based on the final sampled point cloud.

According to still further embodiments of the present disclosure, a method for storing bitstream of a video is provided. The method comprises: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; generating the bitstream based on the final sampled point cloud; and storing the bitstream in a non-transitory computer-readable recording medium.

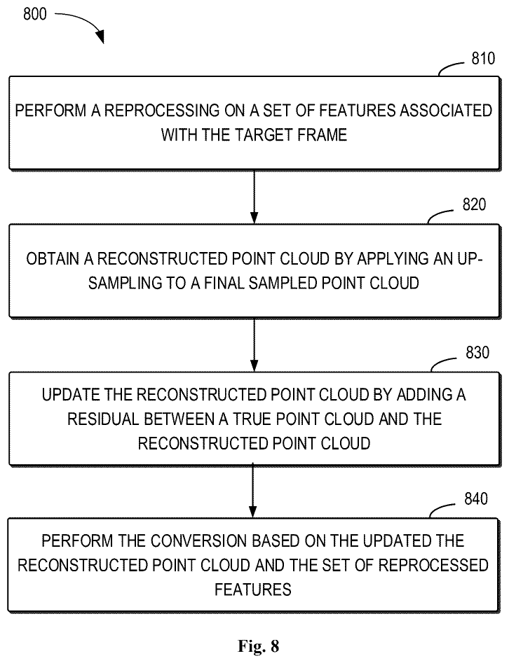

FIG. 8 illustrates a flowchart of a method 800 for video processing in accordance with embodiments of the present disclosure. The method 800 may be implemented during a conversion between a current frame of a point cloud sequence and a bitstream of the point cloud sequence.

At block 810, for a conversion between a target frame of a point cloud sequence and a bitstream of the point cloud sequence, a reprocessing is performed on a set of features associated with the target frame.

At block 820, a reconstructed point cloud is obtained by applying an up-sampling to a final sampled point cloud.

At block 830, the reconstructed point cloud is updated by adding a residual between a true point cloud and the reconstructed point cloud.

At block 840, the conversion is performed based on the updated the reconstructed point cloud and the set of reprocessed features. In some embodiments the conversion may include encoding the target frame into the bitstream. Alternatively, the conversion may include decoding the target frame from the bitstream. Compared with the conversion solution, it can improve point cloud accuracy, and thus improve the efficiency of point cloud coding.

In some embodiments, the final sampled point cloud is coded and indicated to a decoder by an encoder. In some embodiments, the final sampled point cloud is coded by a point cloud codec. For example, the point cloud codec is one of: a geometry based point cloud compression (G-PCC), a video based point cloud compression (V-PCC), or Draco.

In some embodiments, the set of features is coded and indicated to a decoder by an encoder. In some embodiments, the set of features is coded with one of: fixed-length coding, unary coding, or truncated unary coding. In some other embodiments, the set of features is coding in a predictive way.

In some embodiments, the reprocessing is using convolution to expand a feature dimension only. In some other embodiments, the reprocessing is a complex variable-point expansion operation.

In some embodiments, the reprocessing is performed using at least one of: a down-sampling operation, an up-sampling operation, a symmetric structure of variable-point feature expansion operation. In some embodiments, the down-sampling operation of the reprocessing is implemented using sparse convolution. In some embodiments, a plurality of consecutive down-sampling operations is used. For example, three consecutive down-sampling operations are used.

In some embodiments, the up-sampling operation is implemented using lossless sparse deconvolution. In some embodiments, a plurality of consecutive up-sampling operations is used. For example, three consecutive up-sampling operations are used.

In some embodiments, the reconstructed point cloud is obtained directly by up-sampling in one time. In some other embodiments, the reconstructed point cloud is obtained directly by a plurality of progressive up-sampling.

In some embodiments, the reconstructed point cloud is reconstructed using N up-sampling operations, where N is an integer number. In some embodiments, N is pre-defined. Alternatively, N may be indicated to a decoder. In some embodiments, N is coded with one of: fixed-length coding, unary coding, or truncated unary coding. Alternatively, N may be coding in a predictive way.

In some embodiments, a sparse convolution-based generative convolution is used to achieve a point cloud up-sampling. In some other embodiments, a multi-stage unbalanced loss function is used to constrain a neural network during a training process of the up-sampling. For example, a binary cross-entropy value is used as a loss function in a first stage of the multi-stage unbalanced loss function.

In some embodiments, the numbers of points used in the multi-stage unbalanced loss function is different in different stages. In some embodiments, top M % points of importance of real point cloud are used to constrain the reconstructed point cloud a first stage, where M is a positive number. In some other embodiments, top N % points of importance of real point cloud are used to constrain the reconstructed point cloud in a first stage, wherein N is a positive number. In some further embodiments, top K % points of importance of real point cloud are used to constrain the reconstructed point cloud in a last stage, K is a positive number. In some embodiments, M<N<K. For example, M=40, N=70, K=100.

In some embodiments, the residual between the true point cloud and the reconstructed point cloud is learned by a learning-based approach. In some embodiments, a neural network approach is used to learn residuals between up-sampled and real points. In an example, the neural network similar to a U-Net structural network is used to learn the residuals between the reconstructed point cloud and the real point cloud. In another example, the residuals are learned using a U-Net network based on sparse convolution operations.

In some embodiments, the residual between the true point cloud and the reconstructed point cloud is learned using supervised learning. For example, an error between the learned residuals with reconstructed points and the true point is used to update the neural network.

In some embodiments, a chamfer distance is used as a loss function for residual learning. For example, the chamfer distance is computed as the following formula:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2} ,$$

where S₁ and S₂ represents sets of two point clouds, x and y are the coordinates of the points in S₁ and S₂, respectively.

In some embodiments, whether to and/or how to obtain the final sampled point could by combining the plurality of down-sampled points is indicated from an encoder to a decoder in one of: a bitstream, a frame, a tile, a slice, or an octree. In some embodiments, whether to and/or how to obtain the final sampled point could by combining the plurality of down-sampled points is dependent on coding information, wherein the coding information comprises at least one of: dimensions, colour format, colour component, slice type, or picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; and generating the bitstream based on the updated the reconstructed point cloud and the set of reprocessed features.

According to still further embodiments of the present disclosure, a method for storing bitstream of a video is provided. The method comprises: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; generating the bitstream based on the updated the reconstructed point cloud and the set of reprocessed features; and storing the bitstream in a non-transitory computer-readable recording medium.

Implementations of the present disclosure can be described in view of the following clauses, the features of which can be combined in any reasonable manner.

Clause 1. A method of video processing, comprising: applying, for a conversion between a target frame of a point cloud sequence and a bitstream of the point cloud sequence, down-sampling on points in the target frame according to importance of the points; obtaining a final sampled point could by combining a plurality of down-sampled points, wherein a first set of down-sampled points is down-sampled based on importance, and a second set of down-sampled points is down-sampled based on structure-preserving information; and performing the conversion based on the final sampled point cloud.

Clause 2. The method of clause 1, wherein the first set of down-sampled points is obtained based on importance of each point.

Clause 3. The method of clause 2, wherein the importance is evaluated based on a geometric character of point cloud.

Clause 4. The method of clause 3, wherein the geometric character comprises at least one of: a geometric structure, local information of geometry, or global information of geometry.

Clause 5. The method of clause 4, wherein the importance of each point in the point is evaluated using the geometric structure.

Clause 6. The method of clause 4, wherein the geometric structure is characterized using a combination of the local and global geometric information.

Clause 7. The method of clause 6, wherein the local geometric information is represented by a fast point feature histograms of point cloud.

Clause 8. The method of clause 6, wherein the global geometric information is obtained by evaluating clusters among all clusters obtained from a point cloud clustering process.

Clause 9. The method of clause 2, wherein the importance is evaluated based on an attribute character of point cloud.

Clause 10. The method of clause 9, wherein the attribute character comprises color information.

Clause 11. The method of clause 2, wherein the importance is evaluated based on both geometric character and attribute character of point cloud.

Clause 12. The method of clause 2, wherein the importance of each point is obtained using a learning-based approach.

Clause 13. The method of clause 12, wherein a neural network-based learning approach is used to obtain the importance of each point.

Clause 14. The method of clause 13, wherein the neural network which is similar to a U-Net structural network is used.

Clause 15. The method of clause 14, wherein a sparse convolution is used as a basic operation in a convolutional network.

Clause 16. The method of clause 2, wherein the importance of each point in a point cloud associated with the target frame learned by the network is ranked.

Clause 17. The method of clause 2, wherein points with higher importance are sampled by sorting importance in descending order.

Clause 18. The method of clause 1, wherein the structure-preserving information is used to obtain a structure of a point could associated with the target frame.

Clause 19. The method of clause 18, wherein the structure-preserving information is represented by at least one of: a density representation, or a point set representation.

Clause 20. The method of clause 19, wherein the point set representation is used to obtain a backbone structure of the point cloud.

Clause 21. The method of clause 20, wherein a farthest sampling approach is used to obtain a farthest sampled point set.

Clause 22. The method of clause 1, wherein the final sampled point cloud is obtained by combining local and global structure importance and structure preservation information.

Clause 23. The method of clause 22, wherein the first set of down-sampled points is sampled using local and global importance sampling.

Clause 24. The method of clause 23, wherein 10% of points are sampled using the local and global importance sampling.

Clause 25. The method of clause 22, wherein the second set of down-sampled points is sampled using structure retention sampling.

Clause 26. The method of clause 25, wherein 10% of points are sampled using the structure retention sampling.

Clause 27. The method of clause 1, wherein the final sampled point cloud is coded and indicated to a decoder by an encoder.

Clause 28. The method of clause 27, wherein the final sampled point cloud is coded by a point cloud codec.

Clause 29. The method of clause 28, wherein the point cloud codec is one of: a geometry based point cloud compression (G-PCC), a video based point cloud compression (V-PCC), or Draco.

Clause 30. The method of clause 1, wherein a set of features is coded and indicated to a decoder by an encoder.

Clause 31. The method of clause 30, wherein the set of features is coded with one of: fixed-length coding, unary coding, or truncated unary coding.

Clause 32. The method of clause 30, wherein the set of features is coding in a predictive way.

Clause 33. The method of any of clauses 1-32, wherein whether to and/or how to obtain the final sampled point could by combining the plurality of down-sampled points is indicated from an encoder to a decoder in one of: a bitstream, a frame, a tile, a slice, or an octree.

Clause 34. The method of any of clauses 1-32, wherein whether to and/or how to obtain the final sampled point could by combining the plurality of down-sampled points is dependent on coding information, wherein the coding information comprises at least one of: dimensions, colour format, colour component, slice type, or picture type.

Clause 35. A method of video processing, comprising: performing, for a conversion between a target frame of a point cloud sequence and a bitstream of the point cloud sequence, a reprocessing on a set of features associated with the target frame; obtaining a reconstructed point cloud by applying an up-sampling to a final sampled point cloud; updating the reconstructed point cloud by adding a residual between a true point cloud and the reconstructed point cloud; and performing the conversion based on the updated the reconstructed point cloud and the set of reprocessed features.

Clause 36. The method of clause 35, wherein the final sampled point cloud is coded and indicated to a decoder by an encoder.

Clause 37. The method of clause 36, wherein the final sampled point cloud is coded by a point cloud codec.

Clause 38. The method of clause 37, wherein the point cloud codec is one of: a geometry based point cloud compression (G-PCC), a video based point cloud compression (V-PCC), or Draco.

Clause 39. The method of clause 35, wherein the set of features is coded and indicated to a decoder by an encoder.

Clause 40. The method of clause 39, wherein the set of features is coded with one of: fixed-length coding, unary coding, or truncated unary coding.

Clause 41. The method of clause 39, wherein the set of features is coding in a predictive way.

Clause 42. The method of clause 35, wherein the reprocessing is using convolution to expand a feature dimension only.

Clause 43. The method of clause 35, wherein the reprocessing is a complex variable-point expansion operation.

Clause 44. The method of clause 35, wherein the reprocessing is performed using at least one of: a down-sampling operation, an up-sampling operation, a symmetric structure of variable-point feature expansion operation.

Clause 45. The method of clause 44, wherein the down-sampling operation of the reprocessing is implemented using sparse convolution.

Clause 46. The method of clause 45, wherein a plurality of consecutive down-sampling operations is used.

Clause 47. The method of clause 46, wherein three consecutive down-sampling operations are used.

Clause 48. The method of clause 44, wherein the up-sampling operation is implemented using lossless sparse deconvolution.

Clause 49. The method of clause 48, wherein a plurality of consecutive up-sampling operations is used.

Clause 50. The method of clause 49, wherein three consecutive up-sampling operations are used.

Clause 51. The method of clause 35, wherein the reconstructed point cloud is obtained directly by up-sampling in one time.

Clause 52. The method of clause 35, wherein the reconstructed point cloud is obtained directly by a plurality of progressive up-sampling.

Clause 53. The method of clause 52, wherein the reconstructed point cloud is reconstructed using N up-sampling operations, wherein N is an integer number.

Clause 54. The method of clause 53, wherein N is pre-defined, or wherein N is indicated to a decoder.

Clause 55. The method of clause 54, wherein N is coded with one of: fixed-length coding, unary coding, or truncated unary coding, or wherein N is coding in a predictive way.

Clause 56. The method of clause 35, wherein a sparse convolution-based generative convolution is used to achieve a point cloud up-sampling.

Clause 57. The method of clause 35, wherein a multi-stage unbalanced loss function is used to constrain a neural network during a training process of the up-sampling.

Clause 58. The method of clause 57, wherein a binary cross-entropy value is used as a loss function in a first stage of the multi-stage unbalanced loss function.

Clause 59. The method of clause 57, wherein the numbers of points used in the multi-stage unbalanced loss function is different in different stages.

Clause 60. The method of clause 59, wherein top M % points of importance of real point cloud are used to constrain the reconstructed point cloud a first stage, wherein M is a number.

Clause 61. The method of clause 59, wherein top N % points of importance of real point cloud are used to constrain the reconstructed point cloud in a first stage, wherein N is a number.

Clause 62. The method of clause 59, wherein top K % points of importance of real point cloud are used to constrain the reconstructed point cloud in a last stage, wherein K is a number.

Clause 63. The method of any of clauses 60-62, wherein M<N<K.

Clause 64. The method of clause 63, wherein M=40, N=70, K=100.

Clause 65. The method of clause 35, wherein the residual between the true point cloud and the reconstructed point cloud is learned by a learning-based approach.

Clause 66. The method of clause 65, wherein a neural network approach is used to learn residuals between up-sampled and real points.

Clause 67. The method of clause 66, wherein the neural network similar to a U-Net structural network is used to learn the residuals between the reconstructed point cloud and the real point cloud.

Clause 68. The method of clause 67, wherein the residuals are learned using a U-Net network based on sparse convolution operations.

Clause 69. The method of clause 35, wherein the residual between the true point cloud and the reconstructed point cloud is learned using supervised learning.

Clause 70. The method of clause 69, wherein an error between the learned residuals with reconstructed points and the true point is used to update the neural network.

Clause 71. The method of clause 69, wherein a chamfer distance is used as a loss function for residual learning.

Clause 72. The method of clause 71, wherein the chamfer distance is computed as the following formula:

$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2} ,$$

wherein S₁ and S₂ represents sets of two point clouds, x and y are the coordinates of the points in S₁ and S₂, respectively.

Clause 73. The method of any of clauses 35-72, wherein whether to and/or how to obtain the final sampled point could by combining the plurality of down-sampled points is indicated from an encoder to a decoder in one of: a bitstream, a frame, a tile, a slice, or an octree.

Clause 74. The method of any of clauses 35-72, wherein whether to and/or how to obtain the final sampled point could by combining the plurality of down-sampled points is dependent on coding information, wherein the coding information comprises at least one of: dimensions, colour format, colour component, slice type, or picture type.

Clause 75. The method of any of clauses 1-74, wherein the conversion includes encoding the target frame into the bitstream.

Clause 76. The method of any of clauses 1-74, wherein the conversion includes decoding the target frame from the bitstream.

Clause 77. An apparatus for video processing comprising a processor and a non-transitory memory with instructions thereon, wherein the instructions upon execution by the processor, cause the processor to perform a method in accordance with any of clauses 1-34.

Clause 78. A non-transitory computer-readable storage medium storing instructions that cause a processor to perform a method in accordance with any of clauses 1-34.

Clause 79. A non-transitory computer-readable recording medium storing a bitstream of a video which is generated by a method performed by an apparatus for video processing, wherein the method comprises: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; and generating the bitstream based on the final sampled point cloud.

Clause 80. A method for storing a bitstream of a video, comprising: applying down-sampling on points in a target frame of a point cloud sequence according to importance of the points; obtaining a final sampled point could by combining a plurality of down-sampled points, wherein a first set of down-sampled points is down-sampled based on importance, and a second set of down-sampled points is down-sampled based on structure-preserving information; generating the bitstream based on the final sampled point cloud; and storing the bitstream in a non-transitory computer-readable recording medium.

Clause 81. A non-transitory computer-readable recording medium storing a bitstream of a video which is generated by a method performed by an apparatus for video processing, wherein the method comprises: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; and generating the bitstream based on the updated the reconstructed point cloud and the set of reprocessed features.

Clause 82. A method for storing a bitstream of a video, comprising: performing a reprocessing on a set of features associated with a target frame of a point cloud sequence; obtaining a reconstructed point cloud by applying an up-sampling to a final sampled point cloud; updating the reconstructed point cloud by adding a residual between a true point cloud and the reconstructed point cloud; generating the bitstream based on the updated the reconstructed point cloud and the set of reprocessed features; and storing the bitstream in a non-transitory computer-readable recording medium.

### Example Device

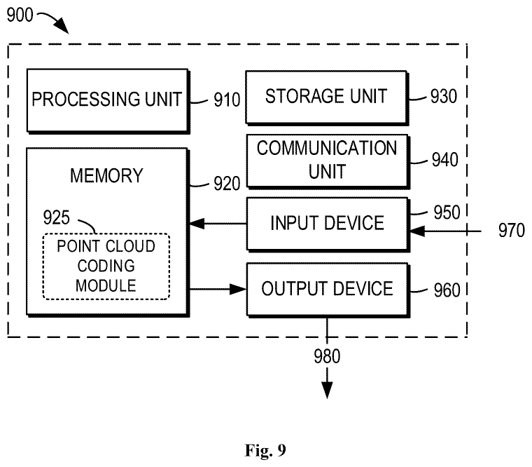

FIG. 9 illustrates a block diagram of a computing device 900 in which various embodiments of the present disclosure can be implemented. The computing device 900 may be implemented as or included in the source device 110 (or the GPCC encoder 116 or 200) or the destination device 120 (or the GPCC decoder 126 or 300).

It would be appreciated that the computing device 900 shown in FIG. 9 is merely for purpose of illustration, without suggesting any limitation to the functions and scopes of the embodiments of the present disclosure in any manner.

As shown in FIG. 9, the computing device 900 includes a general-purpose computing device 900. The computing device 900 may at least comprise one or more processors or processing units 910, a memory 920, a storage unit 930, one or more communication units 940, one or more input devices 950, and one or more output devices 960.

In some embodiments, the computing device 900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 900 can support any type of interface to a user (such as “wearable” circuitry and the like).

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem and the like) enabling the computing device 900 to communicate with one or more other computing devices, if required. Such communication can be performed via input/output (I/O) interfaces (not shown).

In some embodiments, instead of being integrated in a single device, some or all components of the computing device 900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 900 may be used to implement video encoding/decoding in embodiments of the present disclosure. The memory 920 may include one or more video coding modules 925 having one or more program instructions. These modules are accessible and executable by the processing unit 910 to perform the functionalities of the various embodiments described herein.

In the example embodiments of performing video encoding, the input device 950 may receive video data as an input 970 to be encoded. The video data may be processed, for example, by the video coding module 925, to generate an encoded bitstream. The encoded bitstream may be provided via the output device 960 as an output 980.

In the example embodiments of performing video decoding, the input device 950 may receive an encoded bitstream as the input 970. The encoded bitstream may be processed, for example, by the video coding module 925, to generate decoded video data. The decoded video data may be provided via the output device 960 as the output 980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
applying, for a conversion between a target frame of a point cloud sequence and a bitstream of the point cloud sequence, down-sampling on points in the target frame according to importance of the points;
obtaining a final sampled point could by combining a plurality of down-sampled points, wherein a first set of down-sampled points is down-sampled based on importance, and a second set of down-sampled points is down-sampled based on structure-preserving information; and
performing the conversion based on the final sampled point cloud.

2. The method of claim 1, wherein the first set of down-sampled points is obtained based on importance of each point.

3. The method of claim 2, wherein the importance is evaluated based on a geometric character of point cloud, and/or
wherein the importance is evaluated based on an attribute character of point cloud, and/or
wherein the importance is evaluated based on both geometric character and attribute character of point cloud, and/or
wherein the importance of each point is obtained using a learning-based approach, and/or
wherein the importance of each point in a point cloud associated with the target frame learned by the network is ranked, and/or
wherein points with higher importance are sampled by sorting importance in descending order.

4. The method of claim 3, wherein the geometric character comprises at least one of: a geometric structure, local information of geometry, or global information of geometry, and/or
wherein the attribute character comprises color information, and/or
wherein a neural network-based learning approach is used to obtain the importance of each point.

5. The method of claim 4, wherein the importance of each point in the point is evaluated using the geometric structure, and/or
wherein the geometric structure is characterized using a combination of the local and global geometric information, and/or
wherein the neural network which is similar to a U-Net structural network is used.

6. The method of claim 5, wherein the local geometric information is represented by a fast point feature histograms of point cloud, or
wherein the global geometric information is obtained by evaluating clusters among all clusters obtained from a point cloud clustering process, and/or
wherein a sparse convolution is used as a basic operation in a convolutional network.

7. The method of claim 1, wherein the structure-preserving information is used to obtain a structure of a point could associated with the target frame, and/or
wherein the final sampled point cloud is obtained by combining local and global structure importance and structure preservation information, and/or
wherein the final sampled point cloud is coded and indicated to a decoder by an encoder, and/or
wherein a set of features is coded and indicated to a decoder by an encoder.

8. The method of claim 7, wherein the structure-preserving information is represented by at least one of: a density representation, or a point set representation, and/or
wherein the first set of down-sampled points is sampled using local and global importance sampling, and/or
wherein the second set of down-sampled points is sampled using structure retention sampling, and/or
wherein the final sampled point cloud is coded by a point cloud codec, and/or
wherein the set of features is coded with one of: fixed-length coding, unary coding, or truncated unary coding, and/or
wherein the set of features is coding in a predictive way.

9. The method of claim 8, wherein the point set representation is used to obtain a backbone structure of the point cloud, and/or
wherein 10% of points are sampled using the local and global importance sampling, and/or
wherein 10% of points are sampled using the structure retention sampling, and/or
wherein the point cloud codec is one of: a geometry based point cloud compression (G-PCC), a video based point cloud compression (V-PCC), or Draco.

10. The method of claim 9, wherein a farthest sampling approach is used to obtain a farthest sampled point set.

11. The method of claim 1, wherein a reprocessing is performed on a set of features associated with the target frame, a reconstructed point cloud is obtained by applying an up-sampling to a final sampled point cloud, the reconstructed point cloud is updated by adding a residual between a true point cloud and the reconstructed point cloud, and the conversion is performed based on the updated the reconstructed point cloud and the set of reprocessed features.

12. The method of claim 11, wherein the final sampled point cloud is coded and indicated to a decoder by an encoder, and/or
wherein the set of features is coded and indicated to a decoder by an encoder, and/or
wherein the reprocessing is using convolution to expand a feature dimension only, and/or
wherein the reprocessing is a complex variable-point expansion operation, and/or
wherein the reprocessing is performed using at least one of: a down-sampling operation, an up-sampling operation, a symmetric structure of variable-point feature expansion operation, and/or
wherein the reconstructed point cloud is obtained directly by up-sampling in one time, and/or
wherein the reconstructed point cloud is obtained directly by a plurality of progressive up-sampling, and/or
wherein a sparse convolution-based generative convolution is used to achieve a point cloud up-sampling, and/or
wherein a multi-stage unbalanced loss function is used to constrain a neural network during a training process of the up-sampling, and/or
wherein the residual between the true point cloud and the reconstructed point cloud is learned by a learning-based approach, and/or
wherein the residual between the true point cloud and the reconstructed point cloud is learned using supervised learning.

13. The method of claim 12, wherein the final sampled point cloud is coded by a point cloud codec, and/or
wherein the set of features is coded with one of: fixed-length coding, unary coding, or truncated unary coding, and/or
wherein the set of features is coding in a predictive way, and/or
wherein the down-sampling operation of the reprocessing is implemented using sparse convolution, and/or
wherein the up-sampling operation is implemented using lossless sparse deconvolution, and/or
wherein the reconstructed point cloud is reconstructed using N up-sampling operations, wherein N is an integer number, and/or
wherein a binary cross-entropy value is used as a loss function in a first stage of the multi-stage unbalanced loss function, and/or
wherein the numbers of points used in the multi-stage unbalanced loss function is different in different stages, and/or
wherein a neural network approach is used to learn residuals between up-sampled and real points, and/or
wherein an error between the learned residuals with reconstructed points and the true point is used to update the neural network, and/or
wherein a chamfer distance is used as a loss function for residual learning.

14. The method of claim 13, wherein the point cloud codec is one of: a geometry based point cloud compression (G-PCC), a video based point cloud compression (V-PCC), or Draco, and/or
wherein a plurality of consecutive down-sampling operations is used, and/or
wherein a plurality of consecutive up-sampling operations is used, and/or
wherein N is pre-defined, or N is indicated to a decoder, and/or
wherein top M % points of importance of real point cloud are used to constrain the reconstructed point cloud a first stage, wherein M is a number, or
wherein top N % points of importance of real point cloud are used to constrain the reconstructed point cloud in a first stage, wherein N is a number,
wherein top K % points of importance of real point cloud are used to constrain the reconstructed point cloud in a last stage, wherein K is a number, and/or
wherein the neural network similar to a U-Net structural network is used to learn the residuals between the reconstructed point cloud and the real point cloud, and/or
wherein the chamfer distance is computed as the following formula:
$${L}_{CD} ( {S}_{1} , {S}_{2} ) = \frac{1}{\vert {S}_{1} \vert} {\sum }_{x ∈ {S}_{1}} min {‖ x - y ‖}_{2} + \frac{1}{\vert {S}_{2} \vert} {\sum }_{x ∈ {S}_{2}} min {‖ x - y ‖}_{2}$$
wherein S₁ and S₂ represents sets of two point clouds, x and y are the coordinates of the points in S₁ and S₂, respectively.

15. The method of claim 14, wherein three consecutive down-sampling operations are used, and/or
wherein three consecutive up-sampling operations are used, and/or
wherein N is coded with one of: fixed-length coding, unary coding, or truncated unary coding, or
wherein N is coding in a predictive way, and/or
wherein M<N<K, and/or
wherein M=40, N=70, K=100, and/or
wherein the residuals are learned using a U-Net network based on sparse convolution operations.

16. The method of claim 1, wherein the conversion includes encoding the target frame into the bitstream.

17. The method of claim 1, wherein the conversion includes decoding the target frame from the bitstream.

18. An apparatus for video processing comprising a processor and a non-transitory memory with instructions thereon, wherein the instructions upon execution by the processor, cause the processor to perform a method, wherein the method comprises:
applying, for a conversion between a target frame of a point cloud sequence and a bitstream of the point cloud sequence, down-sampling on points in the target frame according to importance of the points;
obtaining a final sampled point could by combining a plurality of down-sampled points, wherein a first set of down-sampled points is down-sampled based on importance, and a second set of down-sampled points is down-sampled based on structure-preserving information; and
performing the conversion based on the final sampled point cloud.

19. A non-transitory computer-readable storage medium storing instructions that cause a processor to perform a method, wherein the method comprises:
applying, for a conversion between a target frame of a point cloud sequence and a bitstream of the point cloud sequence, down-sampling on points in the target frame according to importance of the points;
obtaining a final sampled point could by combining a plurality of down-sampled points, wherein a first set of down-sampled points is down-sampled based on importance, and a second set of down-sampled points is down-sampled based on structure-preserving information; and
performing the conversion based on the final sampled point cloud.

20. A non-transitory computer-readable recording medium storing a bitstream of a point cloud sequence which is generated by a method performed by a point cloud processing apparatus, wherein the method comprises:
applying down-sampling on points in a target frame of a point cloud sequence according to importance of the points;
obtaining a final sampled point could by combining a plurality of down-sampled points, wherein a first set of down-sampled points is down-sampled based on importance, and a second set of down-sampled points is down-sampled based on structure-preserving information; and
generating the bitstream based on the final sampled point cloud.
